(19) United States
(12) Patent Application Publication
(10) Pub. No.: US 2013/0342427 A1
(43) Pub. Date: Dec. 26, 2013

(54) MONITORING THROUGH A TRANSPARENT DISPLAY

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/531,715

(22) Filed: Jun. 25, 2012

(51) Int. Cl. G09G 5/00

(52) U.S. Cl. 345/4

(57) ABSTRACT

Traffic obstacles or other objectives in front of a vehicle or a person can be monitored by using a monitoring system including a display device, a camera unit, and a control unit. The display device includes a transparent display which allows a user to view a scene through the transparent display. The camera unit produces images of the scene. The control unit determines objective(s) according to recognition of the scene images, and transmits objective data corresponding to the objective(s) to the display device. The transparent display of the display device displays objective information indicating virtual image(s) of the objective(s) projected on the transparent display according to the objective data.

### BACKGROUND

1. Technical Field

The present disclosure relates to a monitoring system, and particularly to a monitoring system displaying information as to objectives such as traffic obstacles through a transparent display.

2. Description of Related Art

Traffic accidents are often caused by inattention of the driver of a vehicle. Especially for an emergency service vehicle such as fire fighting truck, ambulance, or police patrol car, traffic accidents are liable to happen when the emergency service vehicle is moving at a high speed when going to the location of the emergency. Although alarms such as sirens can be used, it is still difficult for pedestrians or the driver of other vehicles near to the emergency service vehicle to take evasive action instantly. In addition, traffic accidents are also liable to happen in the dark because vision is then reduced.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a monitoring system of the present disclosure.

FIG. 2 is a schematic diagram of an image of an objective projected on the transparent display shown in FIG. 1.

FIG. 3 is a schematic diagram of displaying objective information through the transparent display shown in FIG. 1.

FIG. 4 is a flowchart of an embodiment of a monitoring method implemented through the monitoring system shown in FIG. 1.

### DETAILED DESCRIPTION

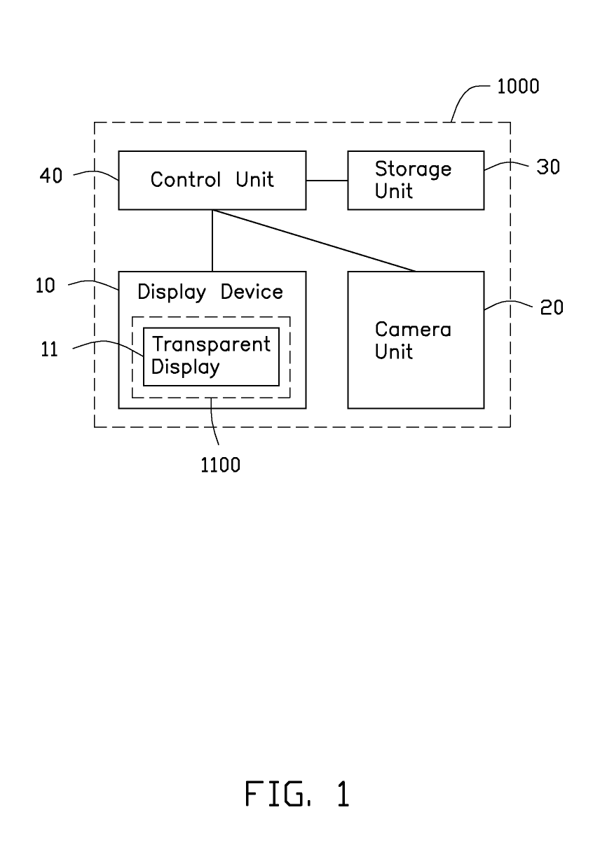

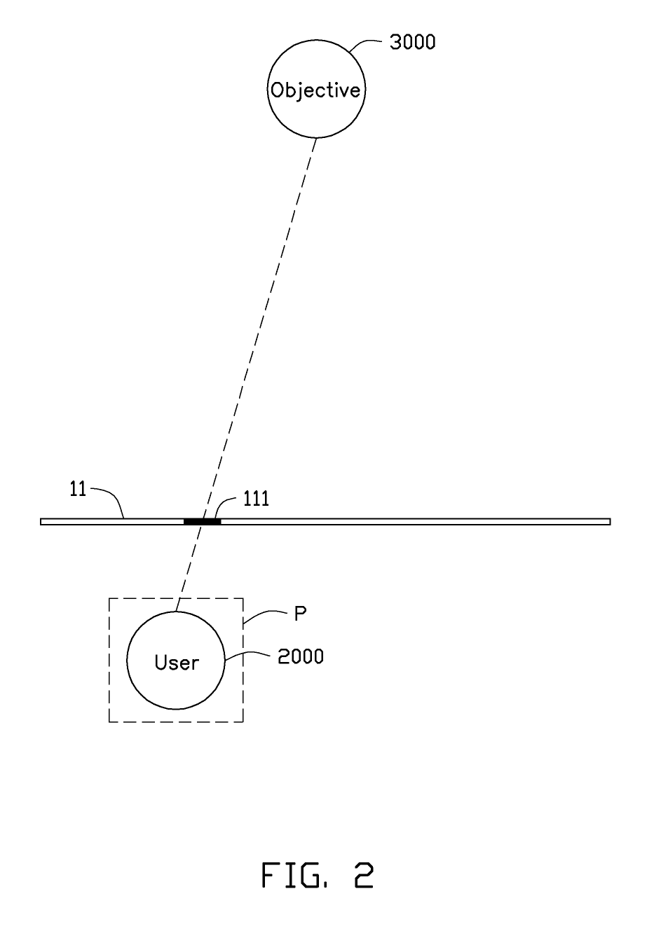

FIG. 1 is a block diagram of an embodiment of a monitoring system of the present disclosure. In the illustrated embodiment, the monitoring system is applied to an vehicle 1000 such as an automobile. In other embodiments, the monitoring system can be applied to other types of vehicles such as ships or airplanes, or applied to other types of devices, for example, portable devices such as helmets or eyeglasses. The monitoring system includes a display device 10, a camera unit 20, a storage unit 30, and a control unit 40. The display device 10 includes a transparent display 11. The transparent display 11 is a transparent portion of the display device 10 such as a display panel which allows a user 2000 (see FIG. 2), for example, the driver of the vehicle 1000, who in the interior of the vehicle 1000 can view a scene outside the vehicle 1000 through the transparent portion, while information such as graphs or characters can be shown on the transparent portion. In the illustrated embodiment, the transparent display 11 is a transparent active-matrix organic light-emitting diode (AMOLED) display disposed on a front window 1100 (that is, the windshield) of the vehicle 1000. The transparent display 11 has a rigid structure, such that the transparent display 11 can be fixed on a frame of the front window 1100. In other embodiments, the transparent display 11 can have a flexible structure, such that the transparent display 11 can be stuck on the glass of the front window 1100. In addition, the transparent display 11 can be another type of transparent/translucent display such as a transparent liquid crystal display (LCD) display, and can be disposed on other windows of the vehicle 1000.

The camera unit 20 automatically produces scene images Gs (not shown) of the scene which can be viewed through the transparent display 11 from the interior of the vehicle 1000. In the illustrated embodiment, the camera unit 20 is disposed at a position corresponding to, for example, the driving seat of the vehicle 1000. In addition, the camera unit 20 includes camera(s) producing the scene images Gs such as still photographs or videos, wherein the camera unit 20 has night-vision functionality such that the scene images Gs can be produced in darkness and in a lighted environment. In other embodiments, the camera unit 20 can be disposed at other positions wherever the user 2000 (see FIG. 2) is located. In addition, the camera unit 20 can include a plurality of cameras producing the scene images Gs from different directions, thereby avoiding dead spots or blind spots.

The storage unit 30 is a device such as a high speed random access memory, a non-volatile memory, or a hard disk drive for storing and retrieving digital information, which stores sample objective data Ds (not shown) including sample objective figures and objective conditions. Herein, “objective” when used as a noun describes an object or a movement or a state (objective conditions) on or of the road which is significant to a driver, “objective data Do” may mean statements or warnings relevant to each objective, “sample objective data Ds” is the generic name of a pre-recorded collection of all such data. These definitions may be specifically extended hereafter. In the illustrated embodiment, the sample objective figures are figures of possible traffic obstacles such as vehicles, humans, animals, huge objects, suspicious objects, or potholes in the road. The objective conditions are the statuses of the possible traffic obstacles which may cause problems to the vehicle 1000. The possible traffic obstacle can correspond to one or more objective conditions when, for instance, the possible traffic obstacle is located in the middle of a road while the vehicle 1000 is approaching, or the possible traffic obstacle is itself approaching the vehicle 1000 at high speed. In other embodiments, the sample objective figures can be figures of other types of possible objectives, for example, particular and favorite objects of the user 2000.

The control unit 40 receives the scene images Gs, and determines objective(s) 3000 (see FIG. 2) according to the scene images Gs by, for instance, using the sample objective data Ds to analyze the scene images Gs by way of comparison. In the illustrated embodiment, the objective 3000 is a traffic obstacle. The control unit 40 compares the scene images Gs with the sample objective figures in the sample objective data Ds to recognize the possible traffic obstacles, and compares the condition of the possible traffic obstacles with the objective conditions in the sample objective data Ds. The control unit 40 then transmits objective data Do (not shown) corresponding to the objective 3000 to the display device 10. For instance, when a possible traffic obstacle is in the middle of a road as determined by the control unit 40 while the vehicle 1000 is approaching, the control unit 40 transmits the objective data Do representing the information of the possible traffic obstacle to the display device 10. In other embodiments, the objective 3000 can be another type of object. The control unit 40 produces the objective data Do to correspond to the objective 3000 while the camera unit 20 can track the objective 3000 when the objective 3000 is moving.

In the illustrated embodiment, the objective data Do includes objective information data Di (not shown) and objective position data Dp (not shown). The control unit 40 produces the objective information data Di including information concerning the objective 3000 such as the name, the type, and/or the description of the objective 3000 according to, for example, the sample objective figure and the objective condition in the sample objective data Ds which correspond to the objective 3000. For instance, when the control unit 40 determines the objective 3000 to be a possible traffic obstacle in the middle of a road according to the sample objective figure and the objective condition corresponding to the objective 3000, the objective information data Di can include the description about the possible traffic obstacle. The pre-stored information concerning the objective(s) 3000 can be in the storage unit 30, or be pre-stored in, and received from, a server connected to the monitoring system through a long distance wireless network, wherein the information can be, for example, an augmented reality information received from the server which is an augmented reality server.

FIG. 2 is a schematic diagram of a virtual image 111 of the objective 3000 projected on the transparent display 11 shown in FIG. 1. The control unit 40 produces the objective position data Dp corresponding to the position of the virtual image 111 of the objective 3000 projected on the transparent display 11, wherein the virtual image 111 is a virtual image viewed from a particular position P where the user 2000 is located. In the illustrated embodiment, the particular position P is predetermined, which can be, for example, the driving seat of the vehicle 1000. The control unit 40 determines the position of the virtual image 111 on the transparent display 11 according to the position of the figure of the objective 3000 in the scene images Gs and the particular position P, and produces the objective position data Dp representing the position(s) of the transparent display 11 adjacent to the position of the virtual image 111 on the transparent display 11. A relative location compensation unit can be used to determine a difference between the relative location (for example, the relative distance and/or the relative direction) between the particular position P and the objective 3000 as well as the relative location between the camera unit 20 and the objective 3000. The control unit 40 can compensate for the difference by, for instance, enabling the camera unit 20 to zoom in or re-orientate according to the difference, or by enabling the control unit 40 to consider the difference when determining the position of the virtual image 111 on the transparent display 11, thereby eliminating any inaccuracies between the display and the factual situation which are caused by the difference.

In other embodiments, the particular position P can be manually configured, or automatically detected by, for instance, using a detection device to detect the position of the user 2000. In this case, the control unit 40 can compensate for a difference between the relative location between the user 2000 and the objective 3000 as well as the relative location between the camera unit 20 and the objective 3000 which has been determined by a relative location compensation unit. In addition, the control unit 40 can produce the objective position data Dp corresponding to the virtual image 111 as viewed from a particular position of other types of devices, for example, helmets or eyeglasses.

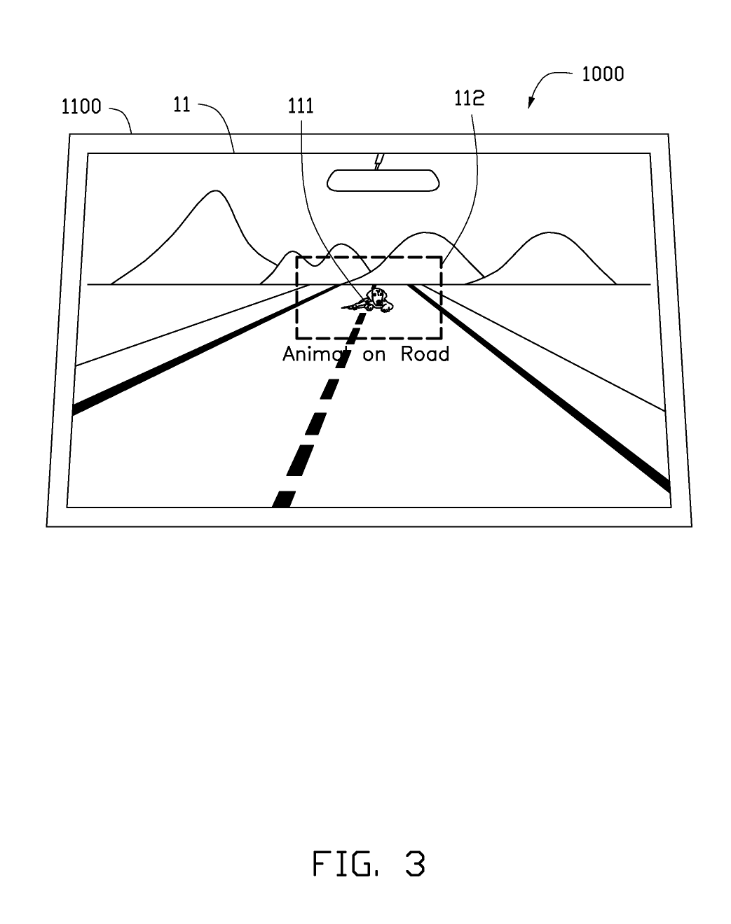

The display device 10 receives the objective data Do from the control unit 40. Objective information 112 (see FIG. 3) is displayed through the transparent display 11 according to the objective information data Di in the objective data Do which includes the information of the objective 3000 and the objective position data Dp in the objective data Do which corresponds to the position(s) of the transparent display 11 corresponding to the position of the virtual image 111, thereby indicating the virtual image 111 through giving a description to accompany the virtual image 111. FIG. 3 is a schematic diagram of displaying the objective information 112 through the transparent display 11 shown in FIG. 1. The objective information 112 representing the information of the objective 3000 is displayed on a position of the transparent display 11 which is adjacent to the position of the virtual image 111 on the transparent display 11, thereby describing the virtual image 111 so as to warn the user 2000 visually of the appearance of the objective 3000. The objective information 112 may include, for example, a graph encircling or pointing to the virtual image 111 and/or characters representing the information concerning the objective 3000. Since the control unit 40 produces the objective data Do corresponding to any movement of the objective 3000, the position of the objective information 112 on the transparent display 11 also changes with the movement of the objective 3000.

In addition to the camera unit 20, other types of sensors can be used to produce environmental data concerning the scene, such that the control unit 40 can identify the objective 3000 to the driver according to the data from the other sensors and the scene images Gs produced by the camera unit 20. For instance, microphones can be used to produce environmental voice data, such that the control unit 40 can identify and describe the objective 3000 audibly as well as by the scene images Gs. In addition to the display device 10 which displays the objective information 112, other types of device can be used to provide objective information. For instance, a loudspeaker can be used to receive the objective data Do from the control unit 40 and produce audible warning(s) according to the objective data Do, thereby warning the user 2000 of the appearance of the objective 3000.

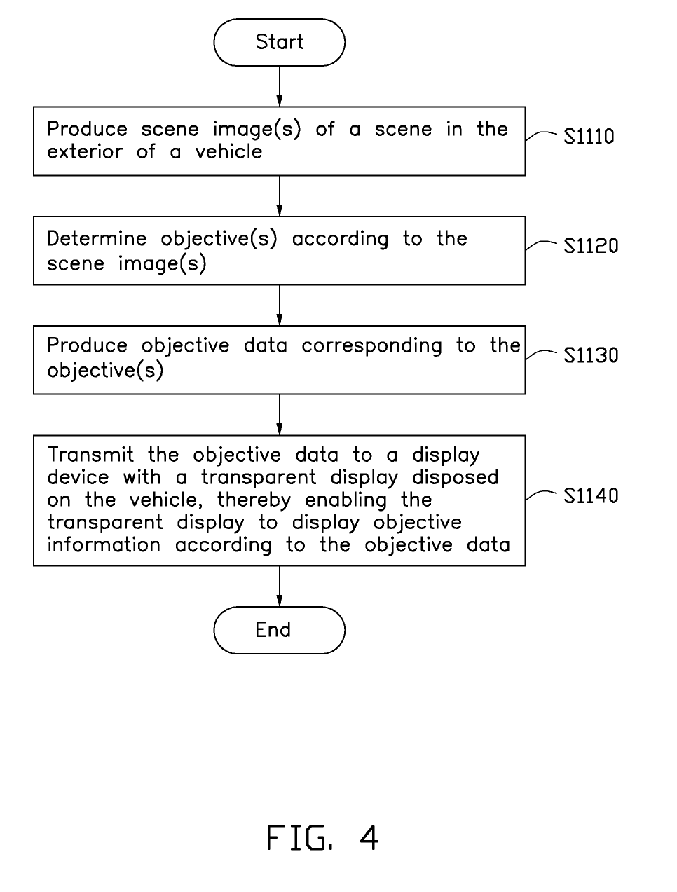

FIG. 4 is a flowchart of an embodiment of a monitoring method implemented through the monitoring system shown in FIG. 1. The monitoring method of the present disclosure follows. Depending on the embodiment, additional steps may be added, others removed, and the ordering of the steps may be changed.

In step S1110, the scene images Gs of the scene outside the vehicle 1000 are produced. The objective 3000 is tracked when the objective 3000 moves. In the illustrated embodiment, camera(s) with night-vision functionality are used to produce the scene images Gs.

In step S1120, the objective 3000 is determined according to the scene images Gs. The objective 3000 can be determined according to the scene images Gs by, for instance, using the sample objective data Ds including the sample objective figures and the objective conditions to analyze the scene images Gs. In the illustrated embodiment, the objective 3000 is determined by comparing the scene images Gs with the sample objective figures to recognize possible traffic obstacles, and the condition of the possible traffic obstacles with the objective conditions is compared.

In step S1130, the objective data Do corresponding to the objective 3000 is produced. The objective data Do is produced to correspond to the movement of the objective 3000 when the objective 3000 moves. In the illustrated embodiment, the objective data Do includes the objective information data Di and the objective position data Dp. The objective information data Di includes the information concerning the objective 3000. The objective position data Dp corresponds to the virtual image 111 of the objective 3000 projected on the transparent display 11, wherein the virtual image 111 is viewed from a particular position P.

In step S1140, the objective data Do is transmitted to the display device 10 with the transparent display 11 disposed in or on the vehicle 1000, thereby enabling the transparent display 11 to display the objective information 112 according to the objective data Do, wherein the objective information 112 indicates the virtual image 111 of the objective 3000 projected on the transparent display 11 by, for instance, accompanying, labeling, or pointing to the virtual image 111. In the illustrated embodiment, the transparent display 11 displays the objective information 112 according to the objective information data Di in the objective data Do, while the objective information 112 is displayed at position(s) of the transparent display 11 which correspond to the objective position data Dp in the objective data Do to accompany the virtual image 111.

The monitoring system is capable of displaying information as to objectives such as traffic obstacles through a transparent display which can be disposed on a windshield window of a vehicle or in a portable device, thereby automatically informing a user about the appearance of the objectives. Camera(s) with night-vision functionality can be used to produce images of the objectives, thereby recognizing the objectives both in darkness and in a lighted environment.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A monitoring system, comprising:
a display device comprising a transparent display allowing a user to view a scene through the transparent display, wherein the transparent display displays one or more objective information indicating one or more virtual images of one or more objectives in the scene projected on the transparent display according to one or more objective data;
one or more camera units producing one or more scene images corresponding to the scene; and
a control unit, wherein the control unit determines the one or more objectives according to the one or more scene images and transmits the one or more objective data corresponding to the one or more objectives to the display device.

2. The monitoring system of claim 1, wherein each of the one or more objectives is a traffic obstacle.

3. The monitoring system of claim 1, wherein the transparent display is disposed on a vehicle, the transparent display allows the user in the interior of the vehicle to view the scene outside the vehicle through the transparent display.

4. The monitoring system of claim 3, wherein the one or more objective data comprises one or more objective position data, the control unit produces the one or more objective position data corresponding to the one or more virtual images of the one or more objectives projected on the transparent display viewed from a particular position, the transparent display displays the one or more objective information at one or more positions of the transparent display according to the one or more objective position data in the one or more objective data.

5. The monitoring system of claim 4, wherein the particular position corresponds to the driving seat of the vehicle.

6. The monitoring system of claim 1, wherein the transparent display comprises at least one of a transparent active-matrix organic light-emitting diode (AMOLED) display and a transparent liquid crystal display (LCD) display.

7. The monitoring system of claim 1, further comprising a storage unit storing one or more sample objective data, wherein the control unit determines the one or more objectives by analyzing the one or more scene images according to the sample objective data.

8. The monitoring system of claim 7, wherein the one or more sample objective data comprises one or more objective conditions, the control unit analyzes the one or more scene images by comparing the condition of one or more possible objectives recognized from the one or more scene images with the one or more objective conditions.

9. The monitoring system of claim 1, wherein the one or more camera units have night-vision functionality.

10. The monitoring system of claim 1, wherein the one or more camera units track the one or more objectives when the one or more objectives move, the control unit produces the one or more objective data to correspond to the movement of the one or more objectives.

11. A monitoring method for a display device comprising a transparent display allowing a user to view a scene through the transparent display, comprising:
producing one or more scene images corresponding to the scene;
determining one or more objectives according to the one or more scene images;
producing one or more objective data corresponding to the one or more objectives; and
transmitting the one or more objective data to the display device with the transparent display allowing the user to view the scene through the transparent display to enable the transparent display to display one or more objective information indicating one or more virtual images of the one or more objectives projected on the transparent display according to the one or more objective data.

12. The monitoring method of claim 11, wherein the transparent display is disposed on a vehicle and allows the user in the interior of the vehicle to view the scene outside the vehicle through the transparent display, the one or more objective data comprises one or more objective position data, the step of producing the one or more objective data comprises:
producing the one or more objective position data in the one or more objective data corresponding to the one or more virtual images of the one or more objectives projected on the transparent display viewed from a particular position;
the step of transmitting the one or more objective data comprises:
transmitting the one or more objective data to the display device with the transparent display disposed on the vehicle to enable the transparent display to display the one or more objective information at one or more positions of the transparent display according to the one or more objective position data in the one or more objective data.

13. The monitoring method of claim 12, wherein the step of producing the one or more objective position data comprises:
producing the one or more objective position data in the one or more objective data corresponding to the one or more virtual images of the one or more objectives projected on the transparent display viewed from the driving seat of the vehicle.

14. The monitoring method of claim 11, wherein the step of determining the one or more objectives comprises analyzing the one or more scene images according to sample objective data to determine the one or more objectives.

15. The monitoring method of claim 14, wherein the one or more sample objective data comprises one or more objective conditions, the step of analyzing the one or more scene images comprises comparing the condition of one or more possible objectives recognized from the one or more scene images with the one or more objective conditions to determine the one or more objectives.

16. The monitoring method of claim 11, wherein the step of producing the one or more scene images comprises using one or more cameras to produce the one or more scene images corresponding to the scene; wherein at least a portion of the one or more cameras have night-vision functionality.

17. The monitoring method of claim 11, further comprising tracking the one or more objectives when the one or more objectives move, wherein the step of producing the one or more objective data comprises producing the one or more objective data to correspond to the movement of the one or more objectives.

18. A computer program product comprising a computer readable storage medium and an executable computer program mechanism embedded therein, the executable computer program mechanism comprising instructions for:
receiving one or more scene images corresponding to a scene;
determining one or more objectives according to the one or more scene images;
producing one or more objective data corresponding to the one or more objectives; and
transmitting the one or more objective data to a display device with a transparent display allowing a user to view the scene through the transparent display to enable the transparent display to display one or more objective information indicating one or more virtual images of the one or more objectives projected on the transparent display according to the one or more objective data.

19. The computer program product of claim 18, wherein the transparent display is disposed on a vehicle and allows the user in the interior of the vehicle to view the scene outside the vehicle through the transparent display, the step of producing the one or more objective data comprises:
producing the one or more objective data comprising one or more objective position data corresponding to the one or more virtual images of the one or more objectives projected on the transparent display viewed from a particular position;
the step of transmitting the one or more objective data comprises:
transmitting the one or more objective data to the display device with the transparent display disposed on the vehicle to enable the transparent display to display the one or more objective information at one or more positions of the transparent display according to the one or more objective position data in the one or more objective data.

20. The computer program product of claim 19, wherein the step of producing the one or more objective data comprises producing the one or more objective data comprising the one or more objective position data corresponding to the one or more virtual images of the one or more objectives projected on the transparent display viewed from the driving seat of the vehicle.
